(19) United States
(12) Patent Application Publication
(10) Pub. No.: US 2010/0089949 A1
(43) Pub. Date: Apr. 15, 2010

(54) DISPENSING DEVICE WITH LOCKING MEMBER

(75) Inventors: Jens Gramann, Munich (DE); Sebastian Guggenmos, Peissenberg (DE); Ingo W. Wagner, Worthsee (DE); Dirk Müller-Paul, Neubeuern (DE)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY, Saint Paul, MN (US)

(21) Appl. No.: 12/596,584

(22) PCT Filed: Apr. 16, 2008
(86) PCT No.: PCT/US08/60428

§ 371 Date: Oct. 19, 2009

(30) Foreign Application Priority Data
Apr. 19, 2007 (GB) 0707573.2

(51) Int. Cl. B67D 7/70; B67D 7/06; B67D 7/78

(52) U.S. Cl. 222/137; 222/153.01; 222/327; 222/145.5

(57) ABSTRACT

A dispensing device (1), for example for dental impression material, comprises a chamber (2, 3) for containing material to be dispensed. The chamber has a dispensing outlet (6) which is so configured that a removable nozzle (7) can be secured thereto to dispense material from the chamber. A locking member (8) is pivotally-movable relative to the chamber into an engaged position (FIG. 2) in which the nozzle is secured to the dispensing outlet by the locking member and the locking member is retained in the engaged position by the nozzle.

### CROSS REFERENCE TO RELATED APPLICATION

This application claims priority from United Kingdom Application No. GB0707573.2, filed Apr. 19, 2007, the disclosure of which is incorporated by reference in its/their entirety herein.

The present invention relates to a dispensing device of the type comprising a chamber having a dispensing outlet to which a removable nozzle can be secured to dispense material from the chamber. The invention relates more especially, but not exclusively, to devices for dispensing materials comprising a mixture of components that are contained separately within the device.

Many different devices are known for dispensing a quantity of material from a chamber within the device. In some cases, the chamber is provided by a disposable container and the dispensing device may then comprise a re-usable housing in which the disposable container is installed for use. Dispensing devices are often provided with a nozzle through which the material is dispensed and it is sometimes desirable to be able to remove the nozzle, for example so that it can be cleaned or replaced if it becomes blocked. Some mechanism is then required for retaining the nozzle in position in the dispensing device particularly if, when material is being dispensed, it is subject to forces tending to displace it relative to the chamber in which the material is contained.

In the field of dentistry, dispensing devices are often used for mixing and dispensing dental compositions comprising a plurality of components. Examples of such compositions are impression materials, restoratives, adhesives, cements, etching gels, and sealants. The components are contained in separate chambers within the dispensing device, from where they are expelled in the required relative amounts into a single dispensing nozzle and mixed prior to being dispensed. A dispensing device may be provided in the form of a cartridge which, for use, is installed in an applicator unit equipped with a suitable mechanism for expelling the component materials.

One applicator unit that is known in the field of dentistry is the Pentamix™ Automatic Mixing Unit available from 3M ESPE AG. That applicator unit is used with a dispensing device in the form of a reusable cartridge comprising two cylindrical compartments having different diameters, into which are placed respective disposable foil bags containing component materials to be mixed and dispensed. Each foil bag has a respective cap that fits onto the rim of the cylindrical compartment in which the bag is located. Each cap has an outlet tube, and a nozzle (or mixing tip) is positioned on the ends of the outlet tubes at the front of the cartridge. The applicator unit includes two motor-driven plungers, each associated with a respective one of the cylindrical compartments of the cartridge. When the applicator unit is operated, the plungers move into the cylindrical compartments of the dispensing device and push material from the foil bags through the outlet tubes and into the nozzle, where the component materials are mixed prior to being dispensed. The nozzle is secured to the cartridge by a lever that is pivotally-hinged to the cartridge at the rear end of the latter. At its front end, the lever has a locking member that engages the nozzle when the lever is lowered into an engaged position. A catch mechanism is provided to hold the lever in the engaged position, and the locking member then retains the mixing/dispensing nozzle in position on the front of the cartridge despite the pressure exerted on it when the component materials are being pushed out of the foil bags.

Dispensing devices of various types, for use in the field of dentistry, are described in EP-A-1 602 342 (3M ESPE AG); US-A-2006/071019 (Engelbrecht); US-A-2006/138166 (Nehren); U.S. Pat. No. 6,311,869 (Wirth et al); and US 2001/004082 (Keller et al).

The present invention is directed to the problem of providing, for a dispensing device of the type comprising a chamber having a dispensing outlet to which a removable nozzle can be secured, a mechanism for retaining the nozzle in position on the outlet that functions reliably but is less complex than known mechanisms, enabling the nozzle to be easily secured in position in the device and subsequently removed therefrom. The invention is further directed to the provision of a dispensing device that can be produced in a cost-effective manner.

The present invention provides a dispensing device comprising a chamber for containing material to be dispensed, the chamber having a dispensing outlet which is so configured that a removable nozzle can be secured thereto to dispense material from the chamber, and a locking member that is pivotally-movable relative to the chamber into an engaged position in which, when the nozzle is present, the nozzle is secured to the dispensing outlet by the locking member and the locking member is retained in the engaged position by the nozzle.

The present invention further provides a dispensing device comprising a chamber for containing material to be dispensed, a nozzle that is removably secured to a dispensing outlet of the chamber to dispense material therefrom, and a locking member that is pivotally-movable relative to the chamber into an engaged position in which it engages the nozzle in such a manner that the nozzle is secured to the dispensing outlet by the locking member and the locking member is retained in the engaged position by the nozzle.

Because the locking member is retained in the engaged position by the nozzle, there is no need for a separate catch mechanism to hold the locking member in the engaged position. The complexity and production costs of the dispensing device can thus be reduced.

Advantageously, the pivotal mounting of the locking member comprises a mechanism operable to retain the locking member in a disengaged position in which a nozzle can be placed on the dispensing outlet of the chamber or, when present, removed therefrom. This facilitates use of the device because it eliminates the need for the locking member to be held manually in the disengaged position while a nozzle is being placed in position, or removed from, the device. Such retaining mechanism may be formed by a bearing member rotatable with the locking member and having at least one flat surface which, when the locking member is in the disengaged position, is in face-to-face engagement with a flat surface in a surrounding housing. A degree of force is then required to rotate the bearing member out of this position so that an inadvertent movement of the locking member out of the disengaged position, for example under its own weight, is inhibited. A retaining mechanism of this type may alternatively, or in addition, be configured to assist in retaining the locking member in the engaged position by providing the bearing member with at least one flat surface which, when the locking member is in the engaged position, is in face-to-face engagement with a flat surface in the surrounding housing. The bearing member may have at least two opposed flat surfaces which, in the disengaged (or, if applicable, engaged) position of the locking member are both in face-to-face engagement with respective flat surfaces in the surrounding housing. In an embodiment of the invention, the bearing member is an integral part of (i.e. formed in one piece with) the locking member.

Preferred materials for the bearing member and the surrounding housing include acrylonitrile-butadiene-styrene terpolymer (ABS), polybutadiene terephthalate (PBT), polyoxymethylene (POM, commonly called acetal), polypropylene, and polyamide. However, any other suitable material could be used including, for example polymethyl methacrylate (PMMA, commonly called acrylic), polystyrene, polycarbonate, and polyethylene. The materials may, if required, be reinforced with glass-fiber. Advantageously, the bearing member and the surrounding housing are formed from the same material, for example polypropylene. In some cases, however, it may be desirable to form the bearing member from a higher strength material than the surrounding housing: this may be the case, for example, when the bearing member is formed in one piece with the locking member. In that case, for example, the bearing member could be formed from polyoxymethylene and the surrounding housing from polypropylene.

The dispensing device may comprises a second chamber for containing material to be dispensed, the second chamber having a respective dispensing outlet which is so configured that the removable nozzle can be secured simultaneously to the dispensing outlets of both chambers to dispense material from both chambers. The nozzle may be configured to mix material from the chambers and to dispense the mixture. The nozzle may be of a known type that, internally, comprises a mixing chamber arranged to receive the materials to be mixed, and a mixing rotor disposed within the mixing chamber. The mixing rotor, which may have peripherally arranged mixing baffles, can be externally driven.

In an embodiment of the invention, the dispensing device comprises one chamber that contains a base material and a second chamber that contains a catalyst material. The base material and the catalyst material, when mixed, may form a hardenable composition, for example a dental impression material. Such dental impression materials, for example, are available under the designation 3M™ ESPE™ Impregum™ Penta™, 3M™ ESPE™ Imprint™ Penta™, 3M™ ESPE™ Position™ Penta™, 3M™ ESPE™ Ramitec™ Penta™ from 3M ESPE AG, Germany. It will, however, be apparent any other materials may be used in a dispensing device in accordance with the present invention.

The/each chamber of a dispensing device in accordance with the invention may be shaped to receive a container of material to be dispensed. Such container may be a foil bag, which may have a cap for fitting with the mouth of the chamber. The cap may comprise the dispensing outlet of the chamber, for example in the form of an outlet tube. The foil bag may contain a dental material, for example a component of a dental impression material, and may be in a form as available from 3M ESPE AG, Germany for use with the 3M™ ESPE™ Pentamix™ Automatic Mixing Unit.

The present invention further provides a dispensing device comprising a cylindrical chamber for containing material to be dispensed; a nozzle that is located on a dispensing outlet of the chamber to dispense material therefrom and is removable therefrom in a direction generally parallel to the longitudinal axis of the chamber; and a locking lever that is pivotally-mounted on the device and movable relative to the chamber into an engaged position in which it extends generally parallel to the longitudinal axis of the chamber; the locking lever comprising locking arms that extend from the locking lever in a direction generally perpendicular thereto and, when the lever is in the engaged position, engage at least partially around the nozzle to secure it to the dispensing outlet; the engagement between the locking arms and the nozzle, when the locking member is in the engaged position, being such that the nozzle retains the locking member in the engaged position.

The dispensing outlet of the chamber may comprise an outlet tube extending from the chamber, generally parallel to the axis of the chamber. The nozzle is moved axially of the outlet tube to locate it on or remove it from the dispensing outlet, and the locking arms engage the nozzle to prevent such movement. The pivotal-mounting of the locking lever may be located at one end of the lever, and the locking arms at the other end.

A dispensing device in accordance with the invention may be provided in combination with a plurality of nozzles that may be identical or of different types.

A dispensing device in accordance with the invention may be provided in combination with an applicator unit, in which case the dispensing device may be in the form of a cartridge that is insertable in and/or removable from the applicator unit. The applicator unit may be a Pentamix™ Automatic Mixing Unit available from 3M ESPE AG, Germany.

By way of example only, a dispensing device in accordance with the invention will be described with reference to the accompanying drawings, in which:

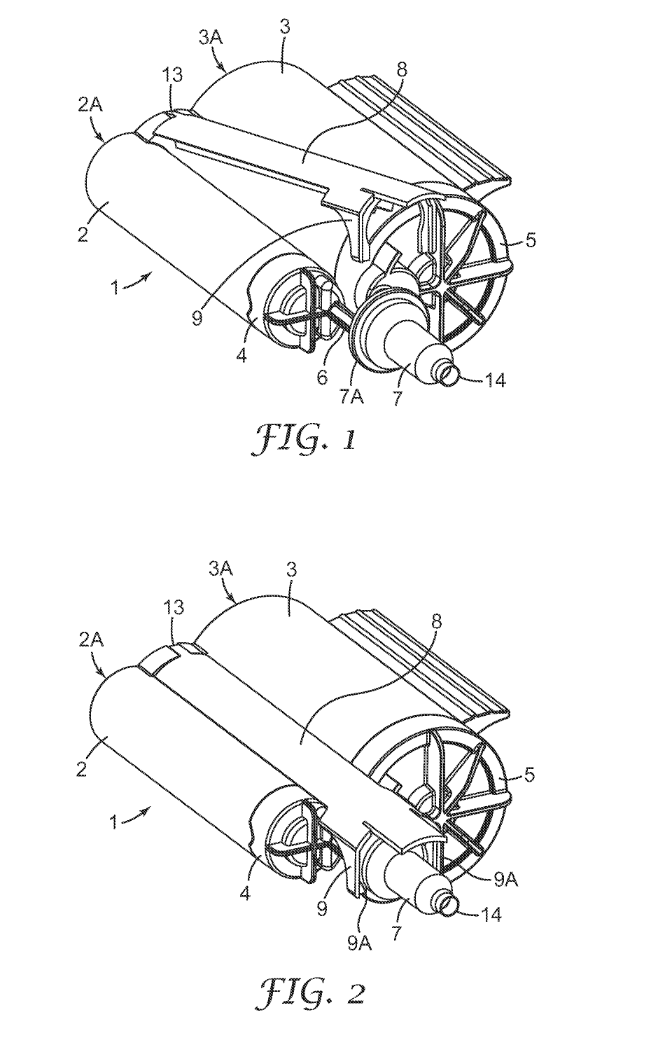

FIG. 1 is a front perspective view of a dispensing device in the form of a cartridge, with a locking lever of the cartridge in a disengaged position;

FIG. 2 is similar to FIG. 1 but shows the locking lever in the engaged position;

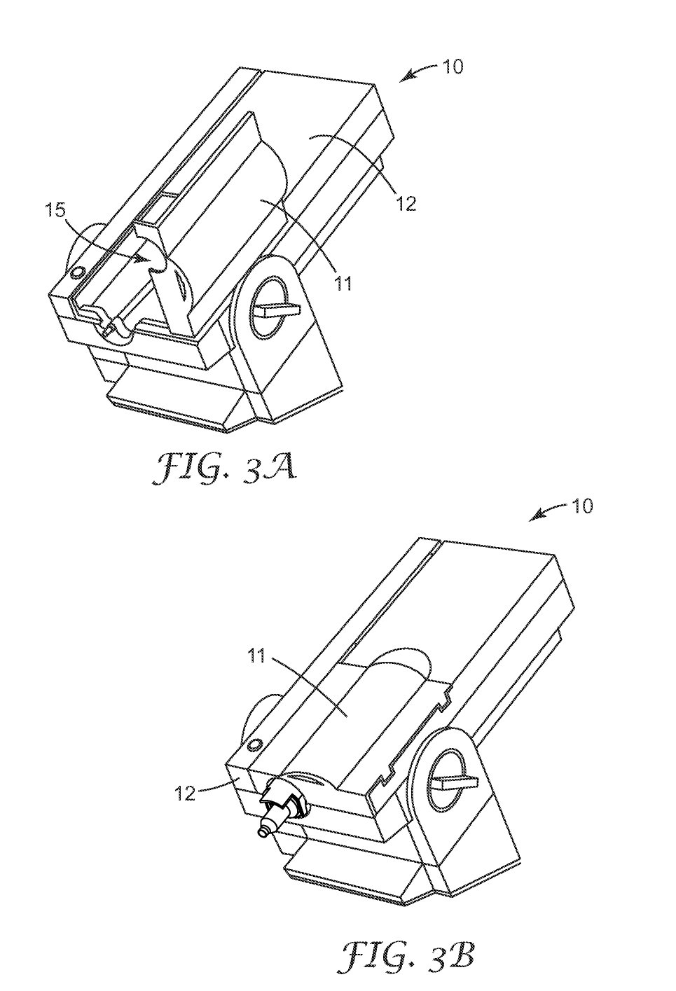

FIGS. 3A and 3B are perspective views of an applicator unit, respectively without and with the cartridge of FIGS. 1 and 2;

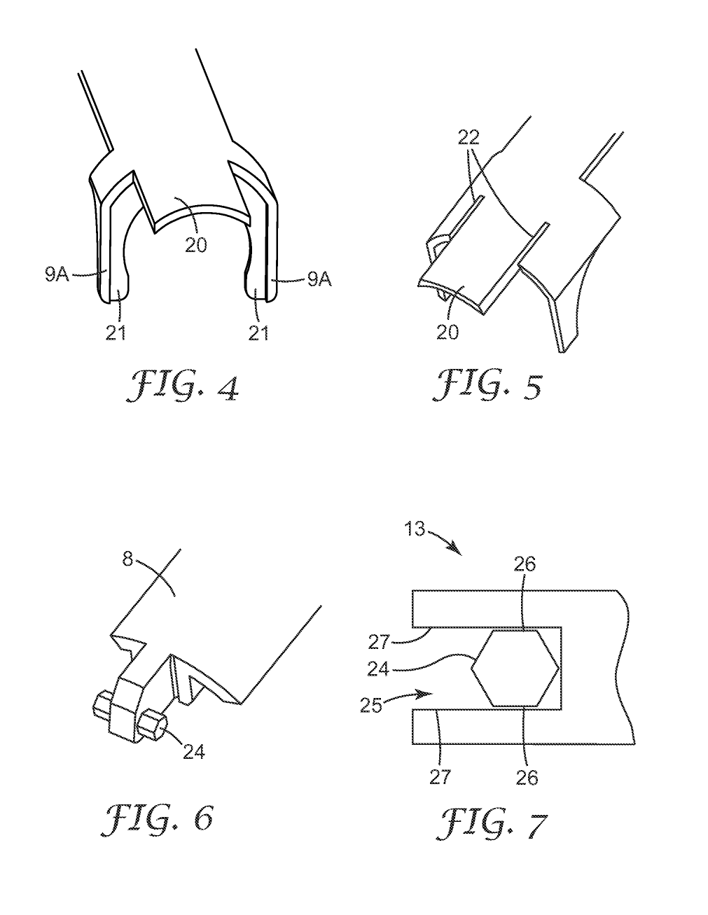

FIGS. 4 and 5 are, respectively, a front view and a perspective view of the locking lever of the cartridge of FIGS. 1 and 2;

FIG. 6 shows the rear end of the locking lever of FIGS. 4 and 5, removed from the cartridge; and

FIG. 7 is a diagrammatic illustration of the rear end of the locking lever, when mounted on the dispensing cartridge.

FIGS. 1 and 2 show a dispensing device in the form of a cartridge 1 for containing two component materials that are to be mixed together and then dispensed. The cartridge is intended to be placed, for use, in an applicator unit that is not shown in these Figures but is illustrated in FIGS. 3A and 3B and described below.

The cartridge 1 comprises two, parallel, cylindrical compartments 2, 3 which, in this case, have circular cross-sections of different diameters. Each compartment contains an appropriately-sized foil bag, providing a chamber that contains one of the component materials that are to be mixed together: only the caps of the foils bags are visible in FIGS. 1 and 2 and are indicated by the reference numerals 4, 5. Each cap 4, 5 fits onto the rim of the compartment 2, 3 in which it is located and has an outlet tube extending generally parallel to the longitudinal axis of the compartment, through which component material from within the respective bag can be expelled: only the outlet tube 6 of the cap 4 is visible in the drawings, in FIG. 1. A dispensing/mixing nozzle 7 is located on the front of the cartridge 1, on the ends of the outlet tubes 6, so that the outlet tubes communicate with a mixing chamber within the nozzle. The nozzle 7 is retained in position on the cartridge 1 by a locking member 8 in the form of a lever that is pivotally-mounted at 13 on the rear of the cartridge and has a locking head 9 at its front end. The locking head comprises two arms 9A arranged in a substantially U-shaped configuration extending generally-perpendicularly from the locking lever 8 and, when the locking lever is moved downwards from the disengaged position shown in FIG. 1 into the engaged position shown in FIG. 2 (in which it is substantially parallel to the longitudinal axes of the compartments 2, 3), the arms 9A engage a circumferential flange 7A at the rear of the mixing nozzle 7 to retain it on the outlet tubes 6 and, hence, retain it in position on the cartridge 1.

The cylindrical compartments 2, 3 are open at their rear ends 2A, 3A to receive respective movable plungers (not shown) that form part of the applicator unit in which the cartridge 1 is located for use. The plungers are motor-driven and, when operated, move into the compartments 2, 3 to exert pressure on the respective foil bags and expel a certain quantity of the contents through the outlet tubes 6 of the respective caps 4, 5 and into the mixing nozzle 7. The mixing nozzle is configured internally to cause the materials from the foil bags to mix with one another during their passage through the nozzle to its outlet 14, from where the mixture is dispensed. The nozzle may, for example, comprise a mixing chamber containing a mixing rotor whereby material that flows into the mixing chamber from the compartments 2, 3 is mixed before being dispensed. The mixing rotor, which may have peripherally arranged mixing baffles, can be externally driven. During this operation, the arms 9A of the locking head 9 hold the mixing nozzle 7 on the outlet tubes of the cartridge 1 securely enough to resist the pressure exerted by the material emerging from the foil bags.

After use of the dispensing device, the mixing nozzle 7 is typically left in position on the cartridge 1 and, depending on the nature of the component materials in the foil bags and the length of time that elapses before the dispensing device is next used, the material contained in the nozzle 7 may harden and block the outlet 14. If that happens, the mixing nozzle 7 must be changed before the dispensing device can be used again, which entails raising the locking lever 8 from the engaged position (FIG. 2) to the disengaged position (FIG. 1), thereby disengaging the arms 9A of the locking head 9 from the mixing nozzle 7 so that the latter can be removed by a movement parallel to the axes of the outlet tubes 6 and replaced by a new nozzle.

Turning now to the locking head 9 of the locking lever 8, it can be seen from FIG. 4 that the locking head is provided with a handle 20 to assist in moving the locking lever between the engaged and disengaged positions. It can also be seen that the inside surfaces 21 of the arms 9A of the locking head 9 are shaped so that the arms are a snap-fit over the mixing nozzle 7 and, in the engaged position (FIG. 2), extend partially around and embrace the nozzle. This requires the arms 9A to be capable of sufficient resilient movement to allow them to be pushed over the mixing nozzle 7, for which purpose slots 22 may be provided in the locking lever 8 on either side of the handle 20, as shown in FIG. 5. The position and design of the slots 22 can be adjusted, as required, to achieve the desired degree of resilient movement of the arms 9A.

The shaping of the inside surfaces 21 of the arms 9A enables the user to sense (through the reaction on the handle 20) when the arms 9A have been pushed over the mixing nozzle 7 into the engaged position of FIG. 2 and, consequently, to know that the mixing nozzle has been properly locked in position on the cartridge 1. In some cases, the fact that the arms 9A have moved into the engaged position may even be detected audibly.

It will be appreciated that the shaping of the inside surfaces 21 of the arms 9A also resists movement of the locking lever 8 out of the engaged position, with the result that it is not necessary to provide any additional mechanism, such as a catch, to hold the locking lever in the engaged position and ensure against its accidental release when material is being dispensed from the mixing nozzle 7. This simplifies use of the cartridge 1 in that the user is not required to release any catch, or similar mechanism, in order to raise the locking lever 8 when the mixing nozzle 7 is to be changed.

An advantageous result of the above-described configuration of the locking head 9 can be understood by reference to FIGS. 3A and 3B, which show a typical applicator unit 10 in which the cartridge 1 may be employed. The applicator unit illustrated is of a type used by a dental practitioner to prepare dental impression material, in which case the larger cylindrical compartment 3 of the cartridge will contain a foil bag of base paste and the smaller diameter compartment 2 will contain a foil bag of catalyst. A cover or lid 11 on the top of the housing 12 of the applicator unit, which prevents dirt or other undesirable substances entering the interior of the unit, lifts up to provide access to a chamber 15 (see FIG. 3A) in which the cartridge is located. When the applicator unit 10 is being prepared for use, the cover 11 is raised, the cartridge 1 is placed in the chamber 15, the mixing nozzle 7 is attached, and the locking lever 8 and the cover 11 are lowered, bringing the unit into the condition shown in FIG. 3B. The mixing nozzle 7 projects outwards from the front of the housing for dispensing impression material when required. The handle 20 on the front of the locking lever likewise projects outwards from the front of the housing 12 and is accessible even when the cover 11 of the housing is closed. Consequently, because there is no catch to be released before the locking lever 8 can be raised, the handle 20 can be used not only to raise the locking lever but also, simultaneously, to lift the cover 11 thereby providing access to the cartridge 1 in a single action when it is necessary to change either the mixing nozzle or the cartridge itself. In some circumstances, the reverse action may also be possible (i.e. the locking lever 8 can be lowered simply by closing the cover 11).

The locking lever 8 which, as mentioned above, is pivotally-mounted on the rear of the cartridge 1, is advantageously provided with a mechanism for ensuring that the lever, once raised, will remain in that position without being supported manually by the user. This facilitates use of the applicator unit 10 because it eliminates the need for the locking lever 8 to be held manually in the disengaged position while a nozzle 7 is being placed in position or removed from the cartridge 1. FIGS. 6 and 7 show how this can be achieved by providing, at the pivotal mounting 13 of the locking lever 8, a multi-faceted (in this case, hexagonal) bearing member 24 that rotates with the lever. The bearing member 24 is confined within a cavity 25 (FIG. 7) in a housing in the cartridge 1 such that opposed faces 26 of the bearing member lie adjacent, and in face-to-face engagement with, the cavity walls 27. The bearing member 24 will thus hold the lever 8 in the associated position unless sufficient force is applied to the lever to cause the stop to rotate to a position in which another pair of opposed faces lies adjacent the cavity walls. One of those positions of the bearing member 24 is selected to correspond to the disengaged position of the locking lever 8 so that, once the lever has been raised to this position, it will remain in place until it is deliberately moved again. The bearing member 24 is advantageously formed from the same material as, and as an integral part of, the locking lever 8: for example, the locking lever 8, including the bearing member 24 may be a one-piece molded plastic component.

Preferred materials for the bearing member 24 and the cartridge housing include acrylonitrile-butadiene-styrene terpolymer (ABS), polybutadiene terephthalate (PBT), polyoxymethylene (POM, commonly called acetal), polypropylene, and polyamide. However, any other suitable material could be used including, for example polymethyl methacrylate (PMMA, commonly called acrylic), polystyrene, polycarbonate, and polyethylene. The materials may, if required, be reinforced with glass-fiber. Advantageously, the bearing member 24 and the cartridge housing are formed from the same material, for example polypropylene. In some cases, however, it may be desirable to form the bearing member 24 from a higher strength material than the housing: this may be the case, for example, when the bearing member 24 is formed in one piece with the locking lever 8 as mentioned above. In that case, for example, the bearing member could be formed from polyoxymethylene and the cartridge housing from polypropylene.

The bearing member 24 may be configured so that opposed faces 26 also lie adjacent, and in face-to-face engagement with, the cavity walls 27 when the locking lever 8 is in the engaged position. In that case, the bearing member 24 assists in retaining the locking lever 8 in the engaged position although, as described above, such assistance is not essential.

It will be appreciated that the exact shaping of the bearing member 24 shown in FIGS. 6 and 7 is not essential. For example, a generally cylindrical stop having a single flat face could be used, with the flat face positioned to be aligned with one of the cavity walls 27 when the locking lever 8 is in the disengaged position. It will also be appreciated that any suitable alternative mechanism, for example a spring or a friction hinge mechanism, could be used to hold the locking lever 8 in the disengaged position.

The locking lever 8 as described above is robust and of simple construction, and can be manufactured cost-effectively. The shaping of the inner surfaces 21 of the locking arms 9A of the lever can be selected to provide secure attachment of the mixing nozzle 7 to the cartridge 1, sufficient to ensure that the nozzle is not displaced even when used to dispense materials of comparatively high viscosity. Nevertheless, the construction of the lever facilitates the process of changing the mixing nozzle of the dispensing cartridge 1 and of accessing the cartridge in the applicator unit 10 when necessary.

It will be understood that the particular cartridge 1 described above is not essential to the functioning of the locking lever 8. A similar locking lever could be used in a cartridge having compartments of similar or equal diameters and/or compartments of other shapes including, for example, cylindrical compartments with oval or D-shaped cross-sections. A similar locking lever could also be used, where appropriate, in any dispensing device comprising a material-containing chamber intended for use with a removable nozzle through which material from the chamber is dispensed. The chamber may be provided by a container, which may be disposable (like the foil bags of the cartridge 1) or reusable, and may be located within a further housing (such as the compartments 2, 3 of the cartridge, or housing 12 of the applicator unit 10). It will also be understood that the removable nozzle need not be one that functions to mix component materials supplied to it but could, simply, just dispense material directly from a single container. On the other hand, the removable nozzle may be adapted to mix together more than two component materials.

Dispensing devices in accordance with the invention are not restricted to use in dispensing dental compositions but can be used, where appropriate, to dispense other types of materials. The may be provided in combination with a set of nozzles, which may be identical or adapted for different uses.

Dispensing devices in accordance with the invention are comparatively easy to handle in that they enable a user to secure a nozzle that has been placed on the dispensing outlet of the device by moving only one part (the locking lever 8 in the example of the device shown in the drawings). Similarly, the user is enabled to release the nozzle for removal by moving only one part. The invention also enables dispensing devices to be provided that are generally less complex and comprise fewer parts and/or are easier to assemble relative to known devices. In particular, in the example described above with reference to the drawings, the use of the locking arms 9A to retain the locking lever 8 in the engaged position makes it unnecessary to provide a separate catch mechanism for that purpose and enables the dispensing device to be produced in a cost-effective manner. The comparatively simple retention mechanism provided by the bearing member 24 is also a factor in enabling cost-effective production.

1. A dispensing device comprising a chamber for containing material to be dispensed, the chamber having a dispensing outlet which is so configured that a removable nozzle can be secured thereto to dispense material from the chamber, and a locking member that is pivotally-movable relative to the chamber into an engaged position in which, when the nozzle is present, the nozzle is secured to the dispensing outlet by the locking member and the locking member is retained in the engaged position by the nozzle.

2. A dispensing device as claimed in claim 1, in which the locking member is pivotally-movable out of the engaged position into a disengaged position in which a nozzle can be placed on the dispensing outlet of the chamber or, when present, removed therefrom.

3. A dispensing device as claimed in claim 1, in which the locking member comprises locking arms that are shaped to engage at least partially around the nozzle to secure it to the dispensing outlet; the engagement between the locking arms and the nozzle, when the locking member is moved into the engaged position, being such that the nozzle retains the locking member in the engaged position.

4. A dispensing device as claimed in claim 3, in which the locking arms are configured to be a snap-fit with the nozzle.

5. A dispensing device as claimed in claim 3, in which the locking arms are resiliently-movable whereby they can be pushed apart by the nozzle during movement of the locking member into the engaged position, and then move back to engage at least partially around the nozzle when the locking member reaches the engaged position.

6. A dispensing device as claimed in 3, in which the locking arms are arranged in a generally U-shaped configuration on the locking member.

7. A dispensing device as claimed in claim 3, in which the locking arms are configured to secure the nozzle to the dispensing outlet by engagement with locking surfaces on the nozzle.

8. A dispensing device as claimed claim 3, in which the locking member comprises a lever that is pivotally-mounted on the device, the pivotal mounting being located at one end of the lever, and the locking arms being located at the other end.

9. A dispensing device as claimed in claim 8, in which slots are provided in the lever, at the said other end, to permit resilient movement of the locking arms whereby they can be pushed apart by the nozzle during movement of the lever into/out of the engaged position.

10. A dispensing device as claimed in claim 2, in which the pivotal mounting of the locking member comprises a mechanism operable to retain the locking member in the disengaged position.

11. A dispensing device as claimed in claim 1, in which the locking member has a handle by which a user can move the locking member into/out of the engaged position.

12. A dispensing device as claimed in claim 1, comprising a second chamber for containing material to be dispensed, the second chamber having a respective dispensing outlet which is so configured that the removable nozzle can be secured simultaneously to the dispensing outlets of both chambers to dispense material from both chambers.

13. A dispensing device as claimed in claim 12, in which the nozzle is configured to mix material from the chambers and to dispense the mixture.

14. A dispensing device as claimed in claim 13, in which one of the chambers contains a base material and the other chamber contains a catalyst material, the base material and the catalyst material, when mixed, forming a dental impression material.

15. A dispensing device as claimed in claim 1, in which the/each chamber is shaped to receive a container of material to be dispensed.

16. An applicator unit comprising a dispensing device as claimed in claim 1, the dispensing device being in the form of a cartridge that is removable from the applicator unit.

17. An applicator unit as claimed in claim 11, in which the handle projects from the applicator unit.

18. An applicator unit as claimed in claim 16, in which movement of the locking member out of the engaged position also opens a lid of the applicator unit to provide access to the cartridge.

19. An applicator unit as claimed in claim 16, the unit comprising means operable to expel material from within the/each chamber through the respective dispensing outlet.

20. An applicator unit as claimed in claim 19, in which the expelling means comprises, for the/each chamber, a respective plunger that is movable into the chamber.
